(19) United States
(12) Patent Application Publication
(10) Pub. No.: US 2006/0213884 A1
(43) Pub. Date: Sep. 28, 2006

(54) Multi-angular laser processing apparatus

(75) Inventor: Chung-Lung Chen, Taipei City (TW)

Correspondence Address: TROXELL LAW OFFICE PLLC;SUITE 1404, 5205 LEESBURG PIKE, FALLS CHURCH, VA, 22041, US

(73) Assignee: Button International Co., Ltd.

(21) Appl. No.: 11/086,340

(22) Filed: Mar. 23, 2005

(51) Int. Cl. B23K 26/06; B23K 26/02

(52) U.S. Cl. 219/121.74; 219/121.82

(57) ABSTRACT

A multi-angular laser processing apparatus includes a laser oscillator for emitting a pulse laser beam, which is refracted and then reflected by first and second reflectors, respectively, to irradiate a workpiece firmly held on a fixing mechanism. In the event of a processing angle within the range of ±20°, a vertical surface of the workpiece may be directly processed using the laser beam without becoming carbonized or charred. It is not necessary to move the workpiece in the course of processing. In the event of a large working area or a processing angle larger than ±20°, the fixing mechanism could be angularly adjusted and a worktable supporting the fixing mechanism could be moved in X and/or Y direction to allow quick and effective processing of the workpiece from multiple angles.

### FIELD OF THE INVENTION

The present invention relates to a laser processing apparatus, and more particularly to a multi-angular laser processing apparatus that uses two reflectors to separately refract and reflect a pulse laser beam, so that the laser beam could be irradiated to a workpiece at different angles to allow direct laser processing of a vertical surface of the workpiece from different angular positions.

### BACKGROUND OF THE INVENTION

In a conventional laser processing apparatus as shown in FIGS. 1 and 2, there is usually a laser oscillator A1 provided over a worktable to emit multiple pulse laser beams A3 having different peak outputs; a polarizing mechanism A2 provided between the laser oscillator A1 and a workpiece B for passing through the laser beams A3 to change and control the processing areas of the laser beams A3; and a worktable (not shown) for holding the workpiece B in place. The worktable is provided with movable parts to allow movement of the worktable in X and/or Y direction in the course of processing. The polarizing mechanism A2 may be adjusted in its position to change the distance “a” in FIG. 1, and accordingly, the focal distance of the polarizing mechanism A2 when the laser beams A3 pass therethrough. Alternatively, the distances “b”, “c”, and “d” in FIG. 2 may be controlled at the same time to adjust the possible processing areas and the intensity of the laser beams A3.

Since the above-described conventional laser processing apparatus uses the adjustment of the focal distance of the polarizing mechanism A2 to control the processing areas and the intensity of the laser beams A3, and the laser beams A3 are irradiated to the workpiece B at a right angle, the laser oscillator A1 could only be vertically moved relative to the workpiece B. When it is desired to process the workpiece B in X and/or Y direction, the worktable is moved forward, backward, leftward, and/or rightward to cover all working angles required for the workpiece B.

However, the above-described laser processing apparatus could only be used to process the workpiece B in X and/or Y direction, but not in vertical or Z direction. In the event of a vertical surface B1 on the workpiece B that is to be processed using the laser beams A3, as shown in FIG. 3, the laser beams A3 emitted from the laser oscillator A1 to perpendicularly irradiate the workpiece B would constantly pass through the vertical surface B1 to repeatedly process the same, resulting in carbonization or charring of an outer side of the vertical surface B1. Although it is also possible to move the worktable in X, Y, and/or Z direction to enable the conventional laser processing apparatus to conduct processing from different angular positions, it takes a lot of time in moving the worktable each time. In other words, the conventional laser processing apparatus has relatively slow processing speed and low working efficiency, and is therefore not economical for use when a large quantity of workpieces are to be processed. Another problem with the conventional laser processing apparatus is the movement of the worktable for adjusting working angles would result in reduced processing accuracy, and require increased labor and time to re-adjust the position of the worktable each time it is moved.

Moreover, it is possible the polarizing mechanism A2 fails to provide an accurate focal distance for any reason, resulting in unstable and uneven output of laser beams A3. The workpiece B is very possibly undesirably damaged in the course of processing due to incorrect focal distance of the polarizing mechanism A2 and/or unstable intensity of the laser beams A3.

Since the conventional laser processing apparatus could only irradiate the laser beams A3 to the workpiece B at a right angle, as shown in FIG. 4, it provides only very limited functions without the ability of processing the workpiece from multiple angular positions to create fine and changeful molds or products. It is therefore desirable to improve the conventional laser processing apparatus.

### SUMMARY OF THE INVENTION

A primary object of the present invention is to provide a multi-angular laser processing apparatus that sequentially refracts and reflects a laser beam to irradiate the same to a workpiece at different angles, so that a vertical surface on the workpiece could be directly processed using the laser beam without becoming carbonized or charred.

Another object of the present invention is to provide a multi-angular laser processing apparatus that allows processing of a fixedly located workpiece without the need of moving any worktable when the processing angle is within a range of ±20°.

A further object of the present invention is to provide a multi-angular laser processing apparatus that allows processing of a workpiece from multiple angular positions to speed the processing and increase the working efficiency without moving the worktable.

A still further object of the present invention is to provide a multi-angular laser processing apparatus that includes rotatable parts to allow adjustment of the workpiece to different angular positions relative to the laser beam, so that the workpiece could be more easily and completely processed from multiple angles using the laser beam.

To achieve the above and other objects, the multi-angular laser processing apparatus according to the present invention mainly includes a laser oscillator for emitting a pulse laser beam, a first reflector for refracting the laser beam emitted from the laser oscillator, a second reflector for reflecting the laser beam refracted by the first reflector to a workpiece, a fixing mechanism for holding the workpiece in place; and a worktable on which the fixing mechanism is firmly mounted.

The fixing mechanism includes a rotary shaft and a rotary disk rotatably mounted on the rotary shaft. The workpiece is fixedly positioned on the rotary disk. The rotary disk may be provided with additional fixtures or fixing means to hold the workpiece in place, so that the workpiece is not easily moved to ensure stable processing thereof.

In a preferred embodiment of the present invention, the rotary shaft is rotatable about an axis thereof within 180 degrees to turn the workpiece relative to the worktable by an angle J.

In a most preferred embodiment of the present invention, the rotary disk is rotatable by 360 degrees to turn the workpiece in a plane by an angle I.

The fixing mechanism may be firmly mounted on the worktable in different manners, such as using scarf joints, screws, etc. Alternatively, the work table may be provided with fixtures to firmly hold the fixing mechanism thereon, ensuring the fixing mechanism does not move in the course of laser processing.

The worktable is movable in both X and Y directions to allow adjustment of an area within which the workpiece could be easily processed.

To use the laser processing apparatus of the present invention, the workpiece is fixedly mounted on the rotary disk of the fixing mechanism. Then, the laser oscillator is actuated to emit the pulse laser beam, which is refracted twice separately by the first and the second reflector before being irradiated to the workpiece to process the latter. In the event of a processing angle within the range of ±20°, a vertical surface of the workpiece may be directly processed using the laser beam without becoming carbonized or charred. In the event of a large working area or a processing angle larger than ±20°, the first and the second reflector may be further adjusted to provide desired refraction angles, the rotary disk and the rotary shaft of the fixing mechanism could be turned and adjusted, and the worktable could be moved in X and/or Y direction at the same time to allow quick and effective processing of the workpiece from multiple angles.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a conventional laser processing apparatus;

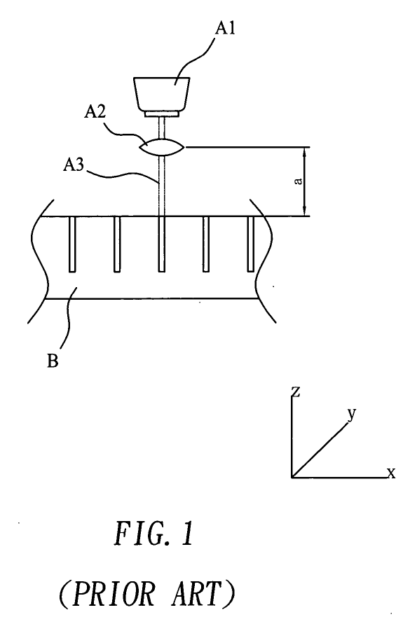

FIG. 2 is another schematic view of the conventional laser processing apparatus of FIG. 1;

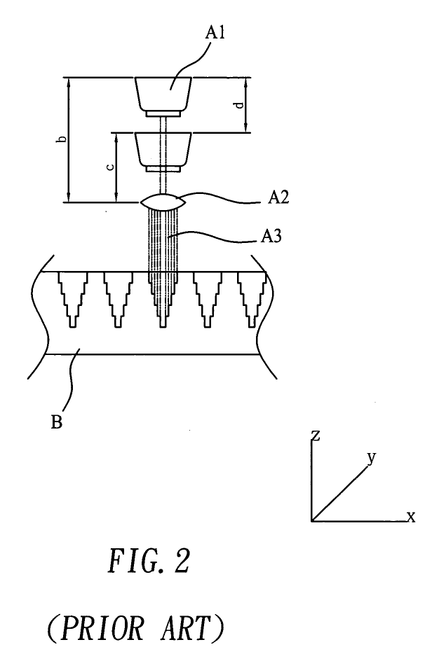

FIG. 3 shows the manner in which the conventional laser processing apparatus of FIG. 1 processes a vertical surface on a workpiece;

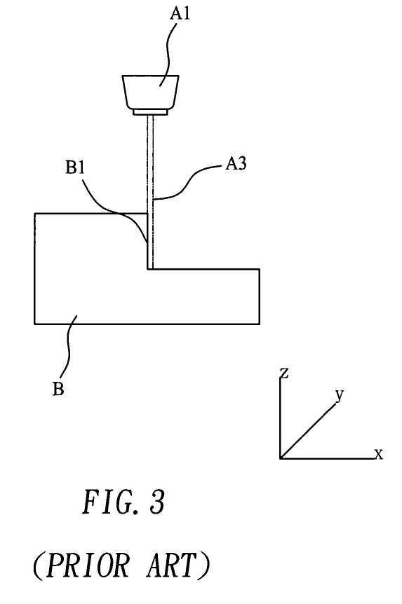

FIG. 4 shows the conventional laser processing apparatus of FIG. 1 irradiates laser beams to a workpiece at a right angle to process the same;

FIG. 5 is a perspective view of a multi-angular laser processing apparatus according to the present invention;

FIG. 6 shows an example of use of the multi-angular laser processing apparatus of the present invention to process a workpiece;

FIG. 7 shows the use of the multi-angular laser processing apparatus of the present invention to process a vertical surface on a workpiece;

FIG. 8 shows the manner of adjusting the multi-angular laser processing apparatus of the present invention to enable processing of a workpiece from different angular positions;

FIG. 9 shows the multi-angular laser processing apparatus of the present invention irradiates laser beams to the workpiece at different angles; and

FIG. 10 shows from different viewing directions a finished product processed using the multi-angular laser processing apparatus of the present invention.

### DETAILED DESCRIPTION OF THE PREFERRED EMBODIMENTS

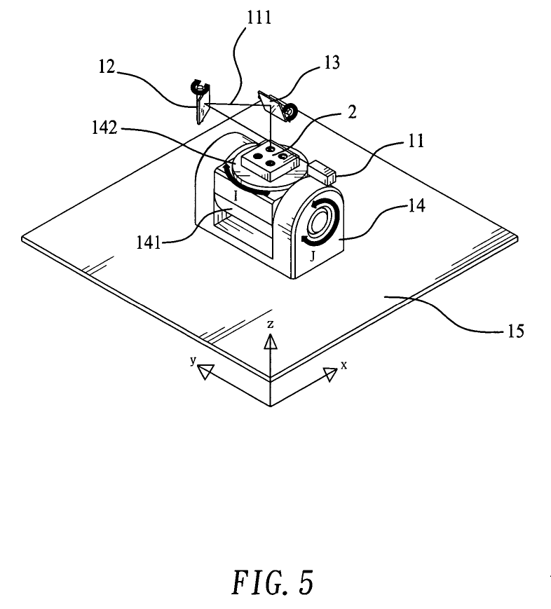

Please refer to FIG. 5 that is a perspective view of a multi-angular laser processing apparatus according a preferred embodiment of the present invention. For the purpose of clarity and conciseness, the present invention is also briefly referred to as “the laser processing apparatus” throughout the specification.

As shown, the laser processing apparatus mainly includes a laser oscillator 11 for emitting a pulse laser beam 111; a first reflector 12 for refracting the pulse laser beam 111 emitted from the laser oscillator 11; a second reflector 13 for reflecting the pulse laser beam 111 refracted by the first reflector 12 to a workpiece 2; a fixing mechanism 14 for holding the workpiece 2 in place; and a worktable 15 on which the fixing device 14 is fixedly mounted.

The fixing mechanism 14 mainly includes a rotary shaft 141, and a rotary disk 142 mounted on the rotary shaft 141 for holding the workpiece 2 thereon. The rotary disk 142 may be provided with additional fixtures or fixing means (not shown) to firmly hold the workpiece 2 thereto, so that the workpiece 2 does not move easily relative to the rotary disk 142 in the course of laser processing.

In the preferred embodiment of the present invention, the rotary shaft 141 is rotatable about its axis within a range of 180 degrees to allow adjustment of an angle J by which the workpiece 2 is rotated related to the worktable 15.

In a most preferred embodiment of the present invention, the rotary disk 142 is rotatable about is axis by 360 degrees to allow adjustment of an angle I by which the workpiece 2 is rotated in a plane relative to the rotary shaft 141.

The fixing mechanism 14 may be firmly mounted on the worktable 15 in different manners, such as using scarf joints, screws, etc. Alternatively, the worktable 15 may be provided with fixtures (not shown) to firmly hold the fixing mechanism 14 thereon, so that it is ensured the fixing mechanism 14 does not move in the course of laser processing.

The worktable 15 is movable in both X and Y directions to allow adjustment of an area with in which the workpiece 2 could be easily processed.

To use the laser processing apparatus of the present invention, the workpiece 2 is fixedly mounted on the rotary disk 142 of the fixing mechanism 14. Then, the laser oscillator 11 is actuated to emit the pulse laser beam 111, which is sequentially refracted twice separately by the first and the second reflector 12, 13 before being irradiated to the workpiece 2 to process the latter. When it is desired to change the angle at which the laser beam 111 is irradiated to the workpiece 2, simply adjust the first and/or the second reflector 12, 13 to desired angular positions, which would change the reflection angle of the first and/or the second reflector 12, 13. The whole laser processing apparatus can therefore be quickly adjusted to different processing angles.

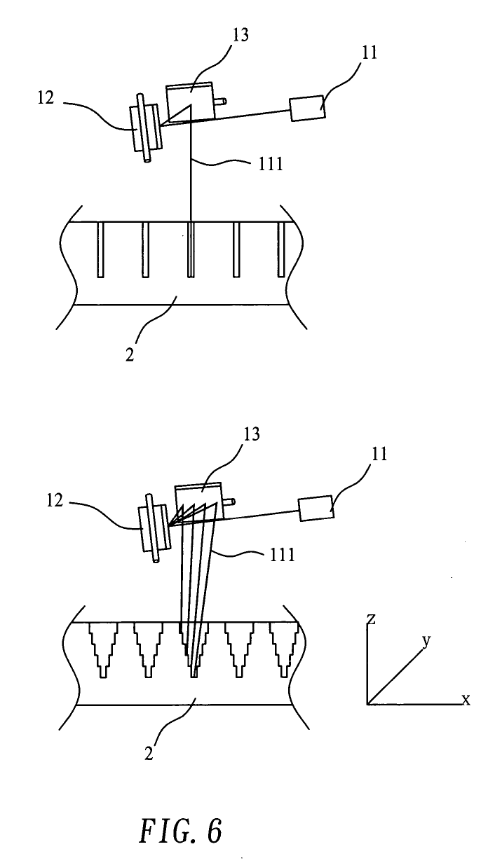

Please refer to FIG. 6 that shows an example of using the laser processing apparatus of the present invention to process the workpiece 2. In this example, the first and the second reflector 12, 13 sequentially refract the pulse laser beam 111 emitted from the laser oscillator 11, so that the refracted pulse laser beam 111 is irradiated to the workpiece 2 at a fixed angle, ensuring the workpiece 2 is processed from an accurate and non-deviated processing angle. When continuous processing is desired, the first and/or the second reflector 12, 13 may be continuously or periodically adjusted to different angular positions to change the irradiation angle of the laser beam 111 without the need of stopping or pausing the processing or moving the worktable 15. In this manner, the laser processing could be more stably and more accurately proceeded at increased speed.

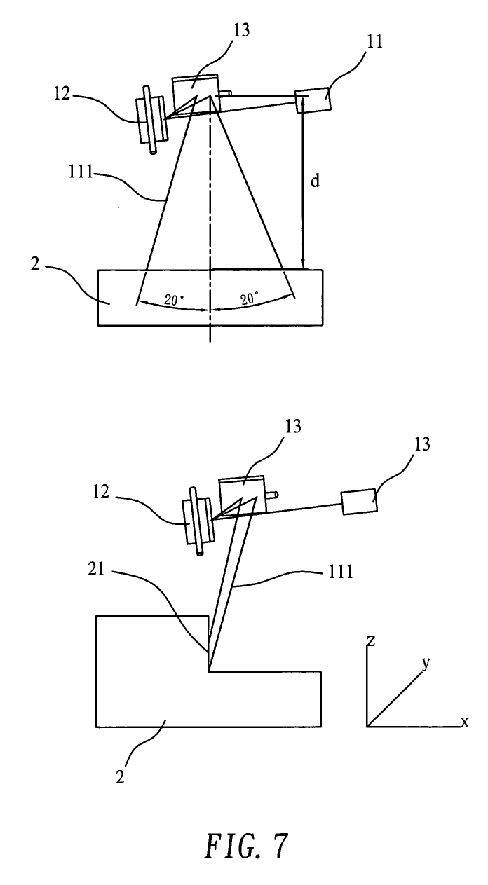

Please refer to FIG. 7 that shows the manner in which the laser processing apparatus of the present invention processes a vertical surface 21 on the workpiece 2. In this case, the first and/or the second reflector 12, 13 is adjusted to a desired refraction angle for changing the angle at which the laser beam 111 is irradiated to the workpiece 2, so that the laser processing apparatus of the present invention provides a processing angle with in the range of ±20°, which allows direct laser processing of the vertical surface 21. In the case the required processing angle is within the range of ±20°, the processing could be directly conducted without the need of moving the worktable 15, and the processing could be done with less working procedures and shortened time.

It is noted the laser beam 111 irradiated to the vertical surface 21 to process the same actually dots the vertical surface 21 instead of constantly passing through it to repeat laser processing at the same position and cause carbonization or charring of an outer side of the vertical surface 21 of the workpiece 2. That is, the laser processing apparatus of the present invention is not only more convenient for use, but also provides increased safety in processing and improved good yield of finished products. It is also possible to produce more changeful products in the laser processing procedures.

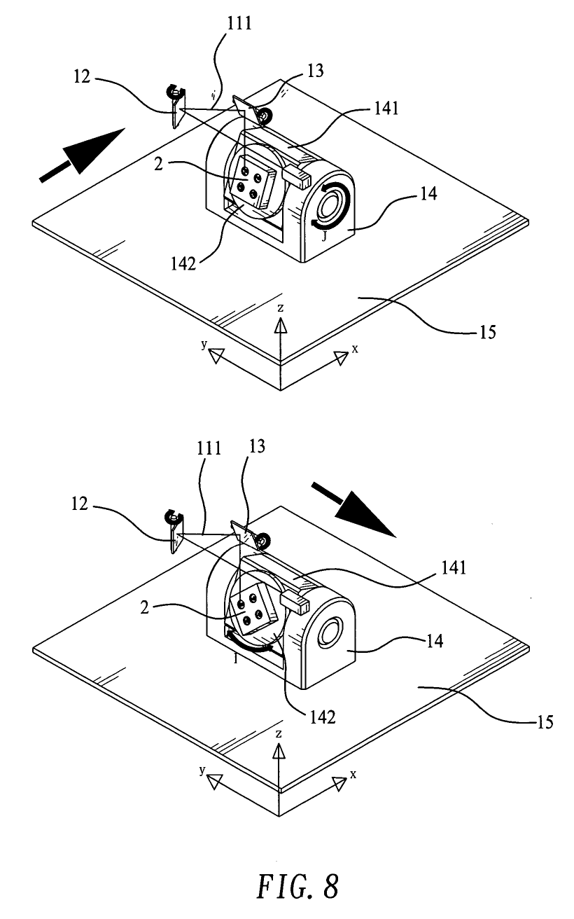

When the vertical surface 21 could only be processed by the laser beam irradiated thereto at a relatively small angle, the rotary disk 142 and the rotary shaft 141 of the fixing mechanism 14 could be turned at the same time by a desired angle I, J, respectively, so that the workpiece 2 is located at an angular position best for processing, as shown in FIG. 8, to enable the vertical surface 21 of the workpiece 2 to be processed from more than one angle. Therefore, the laser processing apparatus of the present invention is more practical for processing a vertical surface on a product because it is not limited by the angular position of the product relative to it.

Please refer to FIG. 8. In the event of a working area exceeded the range of ±20°, it is possible to adjust the worktable 15 in X and/or Y direction to move the workpiece 2 to desired bearings, so that all the selected working areas on the workpiece 2 could be processed using the laser processing apparatus of the present invention without being limited by, for example, the size of the product to be formed from the workpiece 2. Moreover, the first and/or the second reflector 12, 13 could be adjusted to produce a desired refraction angle, and the rotary shaft 141 and the rotary disk 142 could be turned by desired angles J, I to allow processing of the workpiece 2 from different angular positions. In brief, the laser processing apparatus of the present invention allows expanded working areas on a workpiece and is therefore more suitable for processing workpieces of various dimensions.

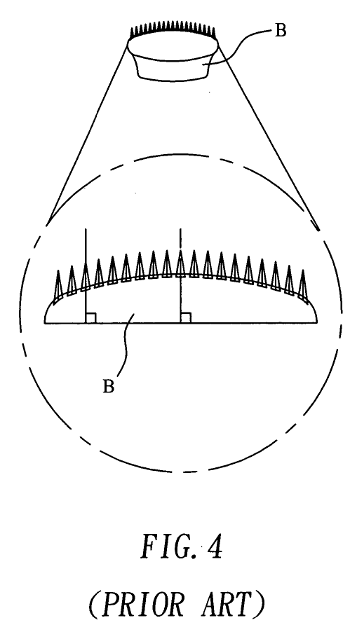

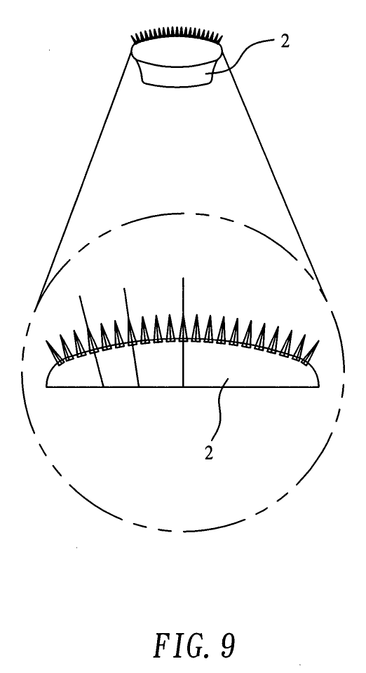

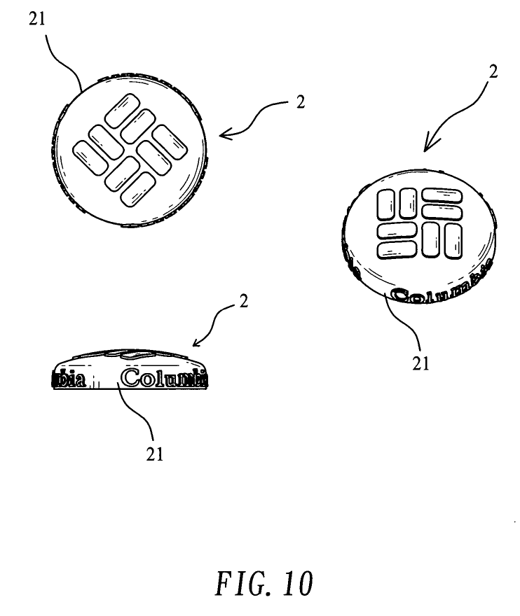

Please refer to FIGS. 9 and 10. Unlike the conventional laser processing apparatus that irradiates the laser beams to the workpiece at a right angle (see FIG. 4), the laser processing apparatus of the present invention irradiates the laser beam to the workpiece 2 at different angles as required in the course of processing, so that the workpiece 2 presents rounded processing angles thereon, making the finished product more changeful and beautiful in its appearance. With the laser processing apparatus of the present invention, changeful patterns could be easily and quickly formed on vertical surfaces of the product at reduced time, procedures, and cost. Moreover, since the laser processing apparatus of the present invention allows processing of a workpiece from various angular positions without the need of moving the workpiece, all the processing procedures could be completed at high efficiency and accuracy.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A multi-angular laser processing apparatus, comprising:
a laser oscillator for emitting a pulse laser beam;
a first reflector for refracting said laser beam emitted from said laser oscillator;
a second reflector for reflecting said laser beam refracted by said first reflector to a workpiece;
a fixing mechanism for holding said workpiece in place; and
a worktable, on which said fixing mechanism is fixedly mounted.

2. The multi-angular laser processing apparatus as claimed in claim 1, wherein said fixing mechanism includes a rotary shaft rotatably mounted thereon.

3. The multi-angular laser processing apparatus as claimed in claim 2, wherein said fixing mechanism includes a rotary disk rotatably mounted on said rotary shaft.

4. The multi-angular laser processing apparatus as claimed in claim 3, wherein said workpiece is fixedly positioned on said rotary disk.

5. The multi-angular laser processing apparatus as claimed in claim 2, wherein said rotary shaft is rotatable about an axis thereof within a range of 180 degrees.

6. The multi-angular laser processing apparatus as claimed in claim 3, wherein said rotary disk is rotatable about an axis thereof by 360 degrees.

7. The multi-angular laser processing apparatus as claimed in claim 4, wherein said rotary disk is rotatable about an axis thereof by 360 degrees.

8. The multi-angular laser processing apparatus as claimed in claim 1, wherein said worktable is movable in X and Y directions.
